(19) United States
(12) Patent Application Publication
(10) Pub. No.: US 2013/0114030 A1
(43) Pub. Date: May 9, 2013

(54) LIQUID CRYSTAL DISPLAY AND METHOD OF MANUFACTURING THE SAME

(71) Applicants: Dong Gi SEONG, Seongnam-si (KR); Joon-Hyung PARK, Seoul (KR); Jin-Lak KIM, Osan-si (KR); Keunchan OH, Cheonan-si (KR); Jinhyeong LEE, Seoul (KR); Kangsub JUNG, Seongnam-si (KR); Kyungseon TAK, Gwangyang-si (KR)

(72) Inventors: Dong Gi SEONG, Seongnam-si (KR); Joon-Hyung PARK, Seoul (KR); Jin-Lak KIM, Osan-si (KR); Keunchan OH, Cheonan-si (KR); Jinhyeong LEE, Seoul (KR); Kangsub JUNG, Seongnam-si (KR); Kyungseon TAK, Gwangyang-si (KR)

(73) Assignee: SAMSUNG ELECTRONICS CO., LTD., Suwon-si (KR)

(21) Appl. No.: 13/439,553

(22) Filed: Apr. 4, 2012

(30) Foreign Application Priority Data
Nov. 8, 2011 (KR) 10-2011-0115803

(51) Int. Cl. G02F 1/1337; B29D 11/00

(52) U.S. Cl. 349/123; 264/1.1; 264/1.36

(57) ABSTRACT

A liquid crystal display includes a first substrate, a second substrate, and a liquid crystal layer disposed between the first substrate and the second substrate. The first substrate includes a first base substrate, a pixel electrode disposed on the first base substrate and including a plurality of branch portions, and a first alignment layer disposed on the pixel electrode. The second substrate includes a second base substrate, a common electrode disposed on the second base substrate, and a second alignment layer disposed on the common electrode.

This application claims priority to Korean Patent Application No. 10-2011-0115803 filed on Nov. 8, 2011, and all the benefits accruing therefrom under 35 U.S.C. §119, the contents of which are herein incorporated by reference in its entirety.

### BACKGROUND

1. Field of Disclosure

The invention relates to a liquid crystal display and a method of manufacturing the liquid crystal display.

2. Description of the Related Art

In general, a liquid crystal display includes two substrates, on which electric field generating electrodes, such as a pixel electrode and a common electrode, are respectively disposed, and a liquid crystal layer interposed between the two substrates. When voltages are applied to the electric field generating electrodes, an electric field is generated in the liquid crystal layer. Due to the electric field, an arrangement of the liquid crystal molecules in the liquid crystal layer is changed and incident lights passing through the liquid crystal layer have different phases from each other. The amount of the lights passing through a polarizer depends on the different phases. Accordingly, the amount of the lights passing through the polarizer is varied by controlling an intensity of the electric field, thereby displaying a desired image.

Since a vertical alignment (“VA”) mode liquid crystal display, in which the liquid crystal molecules in the liquid crystal layer are vertically aligned with respect to the substrates when the electric field is not generated in the liquid crystal layer, has a relatively large contrast ratio, the VA mode liquid crystal display provides excellent display quality. A patterned-vertical alignment (“PVA”) mode liquid crystal display, in which the electric field generating electrodes are provided with cut-away portions, has also been developed so as to broaden a viewing angle thereof.

In order to prevent lowering of the transmittance of the lights due to the cut-away portions, a micro-slit mode or super vertical alignment (“SVA”) mode liquid crystal display has been developed. In the SVA mode liquid crystal display, the arrangement and directivity of the liquid crystal molecules are controlled by the micro-slits of one of the electric field generating electrodes.

### BRIEF SUMMARY

Exemplary embodiments of the invention provide a liquid crystal display capable of preventing a surface afterimage and improving a response speed.

Exemplary embodiments of the invention provide a method of manufacturing the liquid crystal display.

According to the exemplary embodiments, a liquid crystal display includes a first base substrate, a pixel electrode disposed on the first base substrate and including a plurality of branch portions, a first alignment layer disposed on the pixel electrode, a second base substrate, a common electrode disposed on the second base substrate, a second alignment layer disposed on the common electrode, and a liquid crystal layer disposed between the first base substrate and the second base substrate.

The liquid crystal layer includes a liquid crystal expressed by the following Chemical Formulas 1 to 3, or a combination thereof. The first and second alignment layers include a polymer including a structural unit derived from a reactive mesogen expressed by the following Chemical Formula 4.

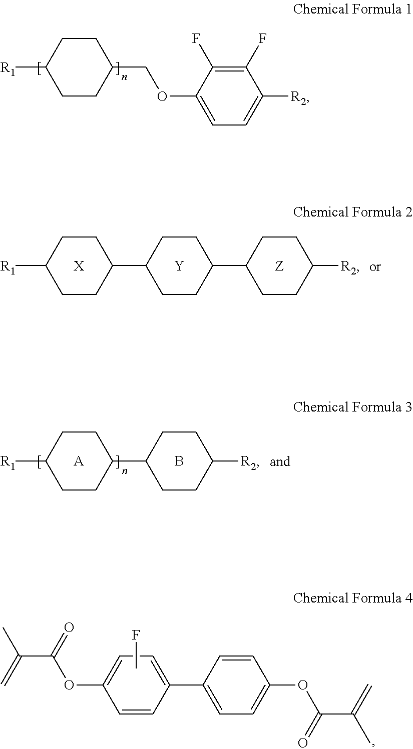

R1 and R2 each independently represent an alkyl group having about 1 to about 10 carbon atoms or an alkyl group having 2 to about 10 carbon atoms in which 1 or 2 —CH₂— groups are optionally replaced by —O—, —CH═CH—, —C(O)—, —OC(O)—, —(O)CO— or —C(O)O—. Each of the rings X, Y, and Z is independently cyclohexyl or phenyl in which at least one hydrogen atom is substituted by F or Cl, each of the rings A and B is independently cyclohexyl or phenyl, and n is a constant number, e.g., 1 or 2.

The liquid crystal layer includes about 10 weight percent to about 30 weight percent of the liquid crystal expressed by the Chemical Formula 1, about 13 weight percent to about 45 weight percent of the liquid crystal expressed by the Chemical Formula 2, and about 30 weight percent to about 60 weight percent of the liquid crystal expressed by the Chemical Formula 3.

The liquid crystal expressed by the Chemical Formula 2 includes liquid crystals expressed by the following Chemical Formulas 5 and 6, and the liquid crystal layer includes about 3 weight percent to about 15 weight percent of the liquid crystals expressed by the Chemical Formula 5 and about 10 weight percent to about 30 weight percent of the liquid crystals expressed by the Chemical Formula 6.

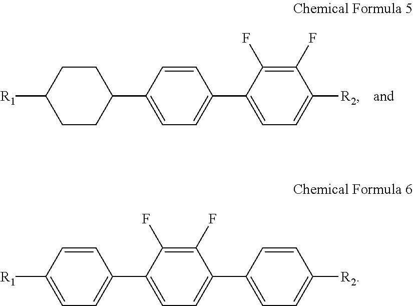

According to the exemplary embodiments, a method of manufacturing a liquid crystal display includes forming a first substrate, forming a second substrate and disposing a liquid crystal mixture including a liquid crystal and a reactive mesogen between the first substrate and the second substrate. The liquid crystal is expressed by the Chemical Formulas 1 to 3 or a combination thereof, and the reactive mesogen is expressed by the Chemical Formula 4. The method further includes providing a light to the liquid crystal mixture to form alignment layers including a structural unit derived from the reactive mesogen on the first substrate and the second substrate, respectively.

The liquid crystal mixture includes about 10 weight percent to about 30 weight percent of the liquid crystal expressed by the Chemical Formula 1, about 13 weight percent to about 45 weight percent of the liquid crystal expressed by the Chemical Formula 2, about weight percent to about 60 weight percent of the liquid crystal expressed by the Chemical Formula 3, and about 0.2 weight percent to about 0.5 weight percent of the reactive mesogen expressed by the Chemical Formula 4.

According to the above, the liquid crystal display may reduce a surface afterimage and have a fast response speed.

### BRIEF DESCRIPTION OF THE DRAWINGS

The above and other features of the invention will become readily apparent by reference to the following detailed description when considered in conjunction with the accompanying drawings wherein:

FIG. 1 is a plan view showing an exemplary embodiment of a pixel according to the invention;

FIG. 2 is a cross-sectional view taken along line I-I′ shown in FIG. 1;

FIG. 3 is an exemplary embodiment of an equivalent circuit diagram of the pixel shown in FIG. 1; and

FIG. 4 is a flowchart showing an exemplary embodiment of a method of manufacturing a liquid crystal display according to the invention.

### DETAILED DESCRIPTION

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “below,” “above” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. “Or” means “and/or.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

“Alkyl” means a straight or branched chain, saturated, monovalent hydrocarbon group (e.g., methyl or hexyl).

Hereinafter, exemplary embodiments of the invention will be explained in detail with reference to the accompanying drawings.

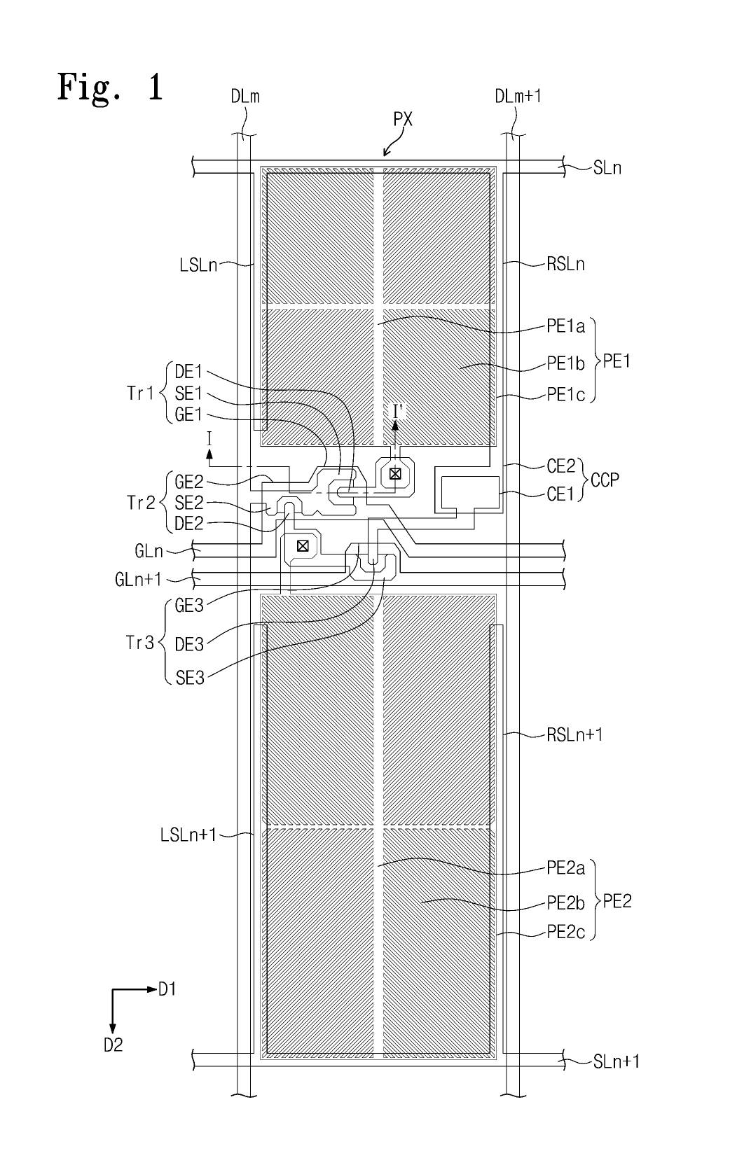

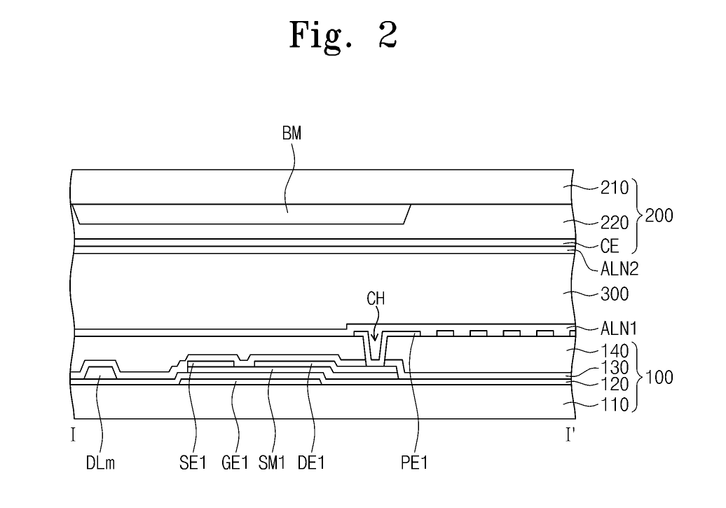

FIG. 1 is a plan view showing an exemplary embodiment of a pixel according to the invention and FIG. 2 is a cross-sectional view taken along line I-I′ shown in FIG. 1. In the exemplary embodiment, the pixel should not be limited to the illustrated layout and structure shown in FIGS. 1 and 2. That is, one pixel may be connected to one gate line and one data line or to one gate line and two data lines according to alternative exemplary embodiments.

Referring to FIGS. 1 and 2, a first substrate 100 includes a first base substrate 110, a plurality of gate lines disposed on the first base substrate 110, a plurality of data lines disposed on the first base substrate 110, and a plurality of pixels PX connected to the gate lines and the data lines.

In FIGS. 1 and 2, for the convenience of explanation, an n-th gate line GLn and an (n+1)th gate line GLn+1 of the gate lines, an m-th data line DLm and an (m+1)th data line DLm+1 of the data lines, and one pixel PX have been shown. In the exemplary embodiment of the liquid crystal display, the other pixels PX have the same structure and function as those of the above-mentioned pixel PX, and thus detailed descriptions of the other pixels will be omitted. In addition, the n-th gate line GLn and the (n+1)th gate line GLn+1 are referred to as first and second gate lines, respectively, and the m-th data line DLm and the (m+1)th data line DLm+1 are referred to as first and second data lines, respectively.

The first and second gate lines GLn and GLn+1 are disposed on the first base substrate 110 and have a longitudinal axis which is extended in a first direction D1. The first and second gate lines GLn and GLn+1 are substantially parallel to each other. A gate insulating layer 120 is disposed on the first base substrate 110 to cover and overlap the first and second gate lines GLn and GLn+1. The first and second data lines DLm and DLm+1 are disposed on the gate insulating layer 120 and have a longitudinal axis which is extended in a second direction D2 crossing the first direction D1. The first and second data lines DLm and DLm+1 are substantially parallel to each other.

A first semiconductor layer SM1 and a second semiconductor layer (not shown) are directly on the gate insulating layer 120. The semiconductor layers may include an active pattern, and an ohmic contact on the active pattern.

Each pixel PX includes a first sub-pixel and a second sub-pixel. The first sub-pixel includes a first thin film transistor Tr1, a first sub-pixel electrode PE1, and a first storage electrode part. The second sub-pixel includes a second thin film transistor Tr2, a second storage electrode part, a third thin film transistor Tr3, a second sub-pixel electrode PE2, and a coupling capacitor CCP. The first and second sub-pixels are disposed between the first data line DLm, and the second data line DLm+1 adjacent to the first data line DLm.

The first thin film transistor Tr1 of the first sub-pixel is connected to the first data line DLm and the first gate line GLn.

The first thin film transistor Tr1 includes a first gate electrode GE1 branched from the first gate line GLn, a first source electrode SE1 branched from the first data line DLm, and a first drain electrode DE1 electrically connected to the first sub-pixel electrode PE1.

The first storage electrode part includes a first storage line SLn having a longitudinal axis which is extended in the first direction D1, and first and second branch electrodes LSLn and RSLn which are branched from the first storage line SLn and have longitudinal axes which are extended in the second direction D2.

The first sub-pixel electrode PE1 is partially overlapped with the first storage line SLn and the first and second branch electrodes LSLn and RSLn to form a first storage capacitor.

The second thin film transistor Tr2 includes a second gate electrode GE2 branched from the first gate line GLn, a second source electrode SE2 branched from the first data line DLm, and a second drain electrode DE2 electrically connected to the second sub-pixel electrode PE2.

The second storage electrode part includes a second storage line SLn+1 having a longitudinal axis which is extended in the first direction D1, and third and fourth branch electrodes LSLn+1 and RSLn+1 which are branched from the second storage line SLn+1 and have longitudinal axes which are extended in the second direction D2.

The first sub-pixel electrode PE1 includes a trunk portion PE1a, a plurality of branch portions PE1b extended from the trunk portion PE1a and spaced apart from each other, and an outer portion PE1c which connects ends of the branch portions PE1b to each other. Similarly, the second sub-pixel electrode PE2 includes a trunk portion PE2a, a plurality of branch portions PE2b extended from the trunk portion PE2a and spaced apart from each other, and an outer portion PE2c which connects ends of the branch portions PE2b to each other. The outer portions PE1c and PE2c of the first and second sub-pixel electrodes PE1 and PE2 may be omitted according to alternative exemplary embodiments.

The trunk portions PE1a and PE2a may have a cross shape, and thus the pixel PX may be divided into a plurality of domains by the trunk portions PE1a and PE2a. The branch portions PE1b and PE2b are arranged in different directions according to the domains. In the exemplary embodiment, the pixel PX may include four domains. The branch portions PE1b and PE2b are spaced apart from each other and substantially parallel to each other in each area defined by the trunk portions PE1a and PE2a, so that they do not make contact with each other. A distance between two adjacent branch portions PE1a and PE1b to each other is measured in terms of a micrometer and may be taken perpendicular to a direction in which the adjacent branch portions PE1a and PE1b extend. The above configuration is to align the liquid crystal molecules of a liquid crystal layer 300 in a specific angle on a surface parallel to the first base substrate 110.

The third thin film transistor Tr3 includes a third gate electrode GE3 branched from the second gate line GLn+1, a third source electrode SE3 extended from the second drain electrode DE2, and a third drain electrode DE3 connected to a coupling capacitor electrode CE1 of the coupling capacitor CCP. The third source electrode SE3 and the second drain electrode DE2 may form a single, unitary, indivisible member. The coupling capacitor electrode CE1 and the third drain electrode DE2 may form a single, unitary, indivisible member. The coupling capacitor electrode CE1 is overlapped with an opposite electrode CE2 extended from the second branch electrode RSLn to form the coupling capacitor CCP. The second branch electrode RSLn and the opposite electrode CE2 may form a single, unitary, indivisible member. However, the structure of the coupling capacitor CCP should not be limited to the exemplary embodiment shown in FIGS. 1 and 2.

Referring to FIG. 2, the first substrate 100 further includes a protective layer 130 and a color filter layer 140. The first and second sub-pixel electrodes PE1 and PE2 are respectively connected to the first and second drain electrodes DE1 and DE2 through contact holes CH while interposing the protective layer 130 and the color filter layer 140 therebetween.

In the exemplary embodiment, the color filter layer 140 is included in the first substrate 100 and disposed between the gate insulating layer 120 and the first and second sub-pixel electrodes PE1 and PE2, but it should not be limited thereto or thereby. That is, the color filter layer 140 may be included in the second substrate 200 or disposed between the other layers.

A first alignment layer ALN1 is disposed on the first substrate 100.

The first alignment layer ALN1 includes a first light alignment layer, and the first light alignment layer includes a polymer comprising a structural unit derived from a reactive mesogen expressed by Chemical Formula 4, e.g., a polymer comprising a structural unit derived from a fluorinated biphenyl dimethacrylate. The first alignment layer ALN1 further includes a first main alignment layer disposed between the first light alignment layer and the first substrate 100, and the first main alignment layer may include a polyimide.

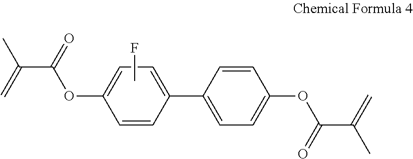

The reactive mesogen expressed in Chemical Formula 4 may be a reactive mesogen expressed by Chemical Formula 7, in which a fluorine is substituted in an ortho-position.

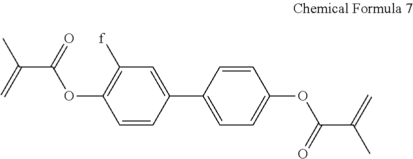

The second substrate 200 includes a second base substrate 210, a black matrix BM, an overcoating layer 220 and a common electrode CE.

The black matrix BM is disposed on the second base substrate 210 to correspond to an area in which the data line DLm is disposed, and thus a light leakage caused by mis-alignment of the liquid crystal molecules may be reduced or effectively prevented.

The overcoating layer 220 is disposed on the second base substrate 210 to cover and overlap the black matrix BM. The overcoating layer 220 reduces a step-difference between the black matrix BM and the second base substrate 210.

The common electrode CE is disposed on the overcoating layer 220 and applied with a predetermined voltage to form the electric field in cooperation with the first and second sub-pixels PE1 and PE2. The common electrode CE may be formed in a single body, such that the common electrode CE forms a single, unitary, indivisible member.

A second alignment layer ALN2 is disposed on the common electrode CE.

The second alignment layer ALN2 includes a second light alignment layer, and the second light alignment layer includes a polymer comprising a structural unit derived from the reactive mesogen expressed by Chemical Formula 4.

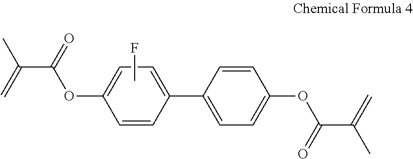

In an embodiment, the reactive mesogen is expressed by Chemical Formula 7.

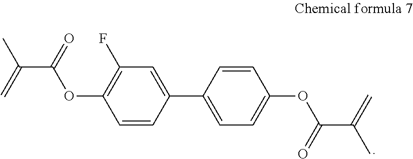 [SMILES: C=C(C)C(=O)Oc1ccc(-c2ccc(OC(=O)C(=C)C)c(F)c2)cc1 ; "."]

The second alignment layer ALN2 further includes a second main alignment layer disposed between the second light alignment layer and the second substrate 200, and the second main alignment layer may include a polyimide.

The liquid crystal layer 300 is disposed between the first alignment layer ALN1 and the second alignment layer ALN2. The liquid crystal molecules of the liquid crystal layer 300 are vertically aligned with respect to the first alignment layer ALN1 and the second alignment layer ALN2 when the electric field is not generated between the pixel electrode PE and the common electrode CE.

The liquid crystal layer 300 includes liquid crystal molecules expressed by Chemical Formula 1, 2 or 3, or a combination thereof.

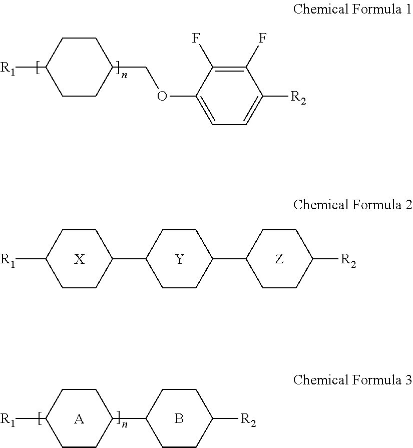

In Chemical Formulas 1 to 3, R₁ and R₂ each independently represent an alkyl group having about 1 to about 10 carbon atoms, or an alkyl group having 2 to about 10 carbon atoms in which 1 or 2 —CH₂— groups are optionally substituted by —O—, —CH═CH—, —C(O)—, —OC(O)—, —(O)CO—, or —C(O)O—. Each of the rings X, Y, and Z is independently cyclohexyl or phenyl in which at least one hydrogen atom is substituted by F or Cl, each of the rings A and B is independently cyclohexyl or phenyl, and n is about 1 to about 10, specifically about 2 to about 8, more specifically 1 or 2.

The liquid crystal layer 300 may include about 10 weight percent (wt %) to about 30 weight percent of the liquid crystal expressed by Chemical Formula 1, about 13 weight percent to about 45 weight percent of the liquid crystal expressed by Chemical Formula 2, and about 30 weight percent to about 60 weight percent of liquid crystal expressed by Chemical Formula 3.

According to exemplary embodiments, the liquid crystal of Chemical Formula 2 may a include liquid crystal expressed by Chemical Formula 5 or 6, or a combination thereof, wherein R₁ and R₂ are as disclosed above.

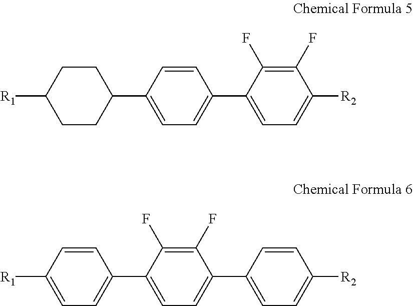

When the liquid crystal layer 300 includes the liquid crystals expressed by Chemical Formula 5 and 6, the liquid crystal layer 300 may include about 3 weight percent to about 15 weight percent of the liquid crystal expressed by Chemical Formula 5 and about 10 weight percent to about 30 weight percent of the liquid crystal expressed by Chemical Formula 6.

According to exemplary embodiments, the liquid crystal expressed by Chemical Formula 3 may be a liquid crystal expressed by Chemical Formulas 8A to 8D, or a combination thereof, in which R₁ and R₂ are as disclosed above.

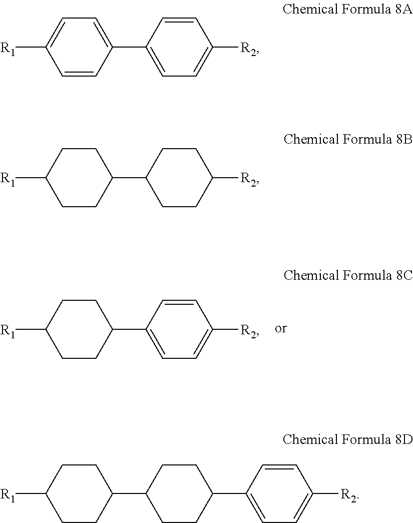

According to an exemplary embodiment, a composition ratio of the liquid crystal is as shown in Table 1, wherein R₁ and R₂ are as disclosed above.

TABLE 1

| | Con- |
|---|---|
| | tent |
| Liquid crystal | (wt %) |
| 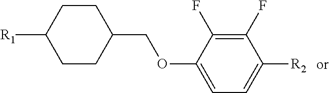 | 10 to 30 |
| 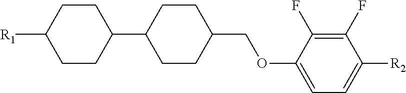 | |
| 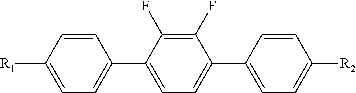 | 3 to 15 |
| 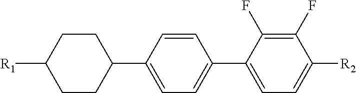 | 10 to 30 |
| 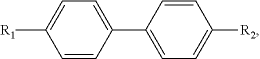 | 30 to 60 |
| 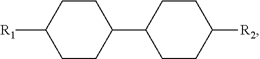 | |
| 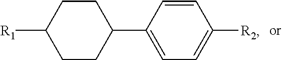 | |
| 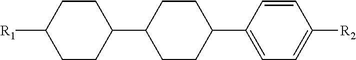 | |

The liquid crystal layer 300 having the above-mentioned composition ratio has an anisotropic refractive index of about 0.080 to about 0.130 and an anisotropic dielectric constant of about −4.0 to about −2.5.

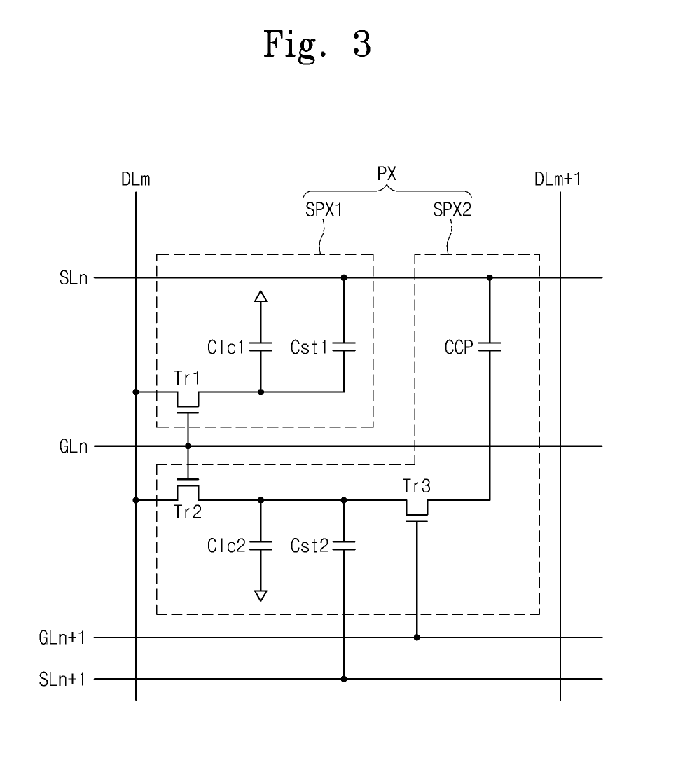

FIG. 3 is an exemplary embodiment of an equivalent circuit diagram of the pixel shown in FIG. 1.

Referring to FIG. 3, each pixel PX includes the first sub-pixel SPX1 and the second sub-pixel SPX2. The first sub-pixel SPX1 includes the first thin film transistor Tr1, a first liquid crystal capacitor Clc1, and a first storage capacitor Cst1. The second sub-pixel SPX2 includes the second thin film transistor Tr2, a second liquid crystal capacitor Clc2, a second storage capacitor Cst2, the third thin film transistor Tr3, and the coupling capacitor CCP. The first and second sub-pixels SPX1 and SPX2 are disposed between the first data line DLm and the second data line DLm+1, which are adjacent to each other. The first thin film transistor Tr1 of the first sub-pixel SPX1 is connected to the first data line DLm and the first gate line GLn, and the second thin film transistor Tr2 of the second sub-pixel SPX2 is connected to the first data line DLm and the first gate line GLn. In detail, the first thin film transistor Tr1 includes the first source electrode connected to the first data line DLm, the first gate electrode connected to the first gate line GLn, and the first drain electrode connected to the first liquid crystal capacitor Clc1. The first storage capacitor Cst1 is connected between the first drain electrode and the first storage line SLn, and connected to the first liquid crystal capacitor Clc1 in parallel. The second thin film transistor Tr2 includes the second source electrode connected to the first data line DLm, the second gate electrode connected to the first gate line GLn, and the second drain electrode connected to the second liquid crystal capacitor Cst2. The second storage capacitor Cst2 is connected between the second drain electrode and the second storage line SLn+1, and connected to the second liquid crystal capacitor Clc2 in parallel.

When a first gate signal is applied to the first gate line GLn, the first and second thin film transistors Tr1 and Tr2 are substantially simultaneously turned on. A data voltage applied to the first data line DLm is applied to the first and second liquid crystal capacitors Clc1 and Clc2 through the turned-on first and second thin film transistors Tr1 and Tr2. Thus, the first and second liquid crystal capacitors Clc1 and Clc2 are charged with the same pixel voltage during a high period of the first gate signal.

The third thin film transistor Tr3 includes the third source electrode connected to the second drain electrode of the second thin film transistor Tr2, the third gate electrode connected to the second gate line GLn+1, and the third drain electrode connected to the coupling capacitor CCP. The second gate line GLn+1 receives a second gate signal that rises after the first gate signal falls. When the third thin film transistor Tr3 is turned on in response to the second gate signal, a voltage division occurs between the second liquid crystal capacitor Clc2 and the coupling capacitor CCP, thereby lowering the pixel voltage charged in the second liquid crystal capacitor Clc2. The lowering level of the pixel voltage depends on the charging rate of the coupling capacitor CCP. Consequently, after the second gate signal is generated, the first liquid crystal capacitor Clc1 is charged with a first pixel voltage and the second liquid crystal capacitor Clc2 is charged with a second pixel voltage lower than the first pixel voltage. Thus, the liquid crystal molecules in an area corresponding to the first sub-pixel electrode PE1 are exposed to an electric field different from an electric field applied to the liquid crystal molecules in an area corresponding to the second sub-pixel electrode PE2, so that the liquid crystal molecules in the area corresponding to the first sub-pixel electrode PE1 are inclined at an angle different from that of the liquid crystal molecules in the area corresponding to the second sub-pixel electrode PE2. Accordingly, the liquid crystal molecules in the two areas have different inclination angles from each other and compensate for the phase delay of the light, thereby improving a side visibility. In other words, the liquid crystal molecules in the two areas form domains with different alignment directions from each other with respect to the vertical direction (e.g., the second direction D2 in the plan view), to thereby improve the side visibility.

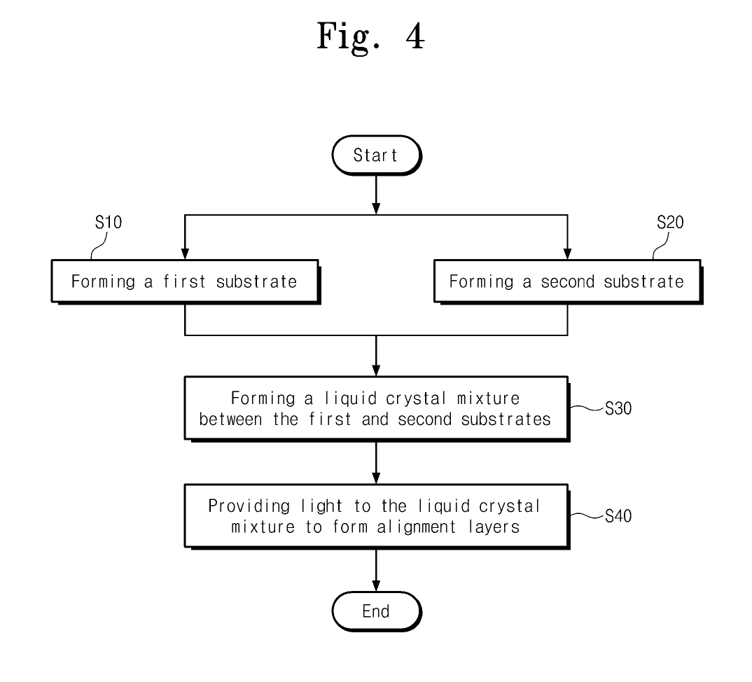

FIG. 4 is a flowchart showing an exemplary embodiment of a method of manufacturing a liquid crystal display according to the invention.

The first substrate and the second substrate are formed (S10 and S20). A liquid crystal mixture including liquid crystals and reactive mesogen is formed between the first substrate and the second substrate (S30). After that, a light is provided to the liquid crystal mixture including the liquid crystals and the reactive mesogen to form an alignment layer (S40), thereby completing a liquid crystal display.

The forming of the first substrate (S10) includes forming the pixel including the pixel electrode on the first base substrate, and the forming of the second substrate (S20) includes forming the common electrode on the second base substrate.

The first substrate is manufactured by forming the gate lines, the data lines and the pixels connected to the gate lines and the data lines on the first base substrate.

The gate lines, the data lines, and the first to third thin film transistors are formed on the first base substrate. The protective layer and the color filter layer are formed on the first base substrate to cover the first to third thin film transistors, and the pixel electrode is formed on the color filter layer to be connected to the first to third thin film transistors through the contact hole. In this case, the pixel electrode includes the first sub-pixel electrode connected to the first thin film transistor and the second sub-pixel electrode connected to the second thin film transistor.

The black matrix is formed on the second base substrate, the overcoating layer is formed on the second base substrate to cover the black matrix, and the common electrode is formed on the overcoating layer.

The first main alignment layer is formed on the first and second sub-pixel electrodes and the second main alignment layer is formed on the common electrode. The first and second main alignment layers may include a polyimide and may be cured using a heat curing process.

Then, the liquid crystal mixture including the liquid crystals and the reactive mesogen, is formed between the first substrate and the second substrate (S30).

The liquid crystal mixture may comprise the liquid crystals expressed by the above-mentioned Chemical Formulas 1 to 3, or a combination thereof. The liquid crystal mixture may include about 10 weight percent to about 30 weight percent of the liquid crystals expressed by the Chemical Formula 1, about 13 weight percent to about 45 weight percent of the liquid crystals expressed by the Chemical Formula 2, and about 30 weight percent to about 60 weight percent of the liquid crystals expressed by the Chemical Formula 3.

According to exemplary embodiments, the liquid crystal expressed by the Chemical Formula 2 may include the liquid crystals expressed by the Chemical Formulas 5 and 6.

In the embodiment wherein the liquid crystal layer includes the liquid crystal expressed by the Chemical Formulas 5 and 6, the liquid crystal mixture may include about 3 weight percent to about 15 weight percent of the liquid crystal expressed by the Chemical Formula 5 and about 10 weight percent to about 30 weight percent of the liquid crystal expressed by the Chemical Formula 6.

According to exemplary embodiments, the liquid crystal expressed by the Chemical Formula 3 may be a liquid crystal expressed by the Chemical Formulas 8A to 8D, or a combination thereof.

The reactive mesogen is a photo-cross-linkable molecule including a mesogen group of the liquid crystal, a prepolymer (e.g., a monomer or oligomer) including the mesogen group of the liquid crystal, or a copolymer including the mesogen group of the liquid crystal. The light may be an ultraviolet light and the reactive mesogen may include a reactive functional group which reacts upon exposure to the light. The reactive mesogen may include the reactive mesogen expressed by the Chemical Formula 4. An embodiment wherein the reactive mesogen comprises the reactive mesogen of Chemical Formula 7 is specifically mentioned.

In an embodiment, the liquid crystal mixture may include about 0.2 weight percent to about 0.5 weight percent of the reactive mesogen expressed by the Chemical Formula 4. Also, a structural unit derived from the reactive mesogen of Chemical Formula 4 may be present in the liquid crystal layer in an amount of about 0.2 weight percent to about 0.5 weight percent, based on the total weight of the liquid crystal layer.

Then, an exposure process is carried out to provide the light to the liquid crystal mixture including the liquid crystals and the reactive mesogen, and thus the alignment layers are respectively formed on the first and second substrates (S40).

The forming of the alignment layer includes an electric field exposure process and a non-electric field exposure process. In the electric field exposure process, the electric field is formed between the pixel electrode and the common electrode while the light is provided to the liquid crystal mixture including the liquid crystals and the reactive mesogen. In the non-electric field exposure process, the electric field is not formed between the pixel electrode and the common electrode while the light is provided to the liquid crystal mixture.

In the electric field exposure process, the electric field is applied to the liquid crystal mixture including the liquid crystals and the reactive mesogen when the voltages are respectively applied to the pixel electrode and the common electrode. When the electric field is applied, the liquid crystal molecules in the liquid crystal mixture are aligned in a predetermined direction. When the electric field is applied while the light is provided to the liquid crystal mixture, the reactive mesogen in the liquid crystal mixture is photo-polymerized, thereby forming the first and second light alignment layers. The first and second light alignment layers are formed on the first and second main alignment layers, respectively. Where the electric field exists in the liquid crystal mixture, the liquid crystal molecules disposed adjacent to the first and second main alignment layers are arranged substantially parallel to the branch portions of the first and second sub-pixel electrodes. The reactive mesogen existing in the liquid crystal mixture is cured to have the same inclination angle as the liquid crystal molecules disposed above the first and second main alignment layers, by the light irradiated thereto. Although the electric field is removed from the liquid crystal mixture, a side chain of the polymer formed from the reactive mesogen maintains the directivity of the liquid crystal molecules adjacent thereto.

In the non-electric field exposure process, the reactive mesogen not reacted in the electric field exposure process (hereinafter, referred to as residual reactive mesogen) is additionally reacted. Accordingly, the first and second light alignment layers are uniformly formed, thereby reducing afterimages caused by the residual reactive mesogen.

A liquid crystal display device including liquid crystal molecules pretilted may be formed by forming an alignment layer including polymerized reactive mesogen. The pretilted liquid crystal molecules of are considered a distinct structural characteristic of the final liquid crystal display device. Since the pretilted liquid crystal molecules is imparted by the formed alignment layer having specific material characteristics through a manufacturing process, such forming of the alignment layer is considered to impart the distinct structural characteristic of the pretilted liquid crystal molecules of the final liquid crystal display device.

Since the pretilted liquid crystal molecules is imparted by forming the alignment layer through a first electric field exposure process and a second non-electric field exposure process, such processes are considered as imparting the distinct structural characteristic of the pretilted liquid crystal molecules of the final liquid crystal display device.

Table 2 shows an amount of the residual reactive mesogen in weight percent (wt %), based on the total starting amount of reactive mesogen, as a function of time in minutes (min) when carried out using the non-electric field exposure process. In Table 2, a commercially available liquid crystal display (Comparative Example), an exemplary embodiment of a liquid crystal display including the liquid crystal mixture in which a terphenyl group is not present (Example 1), and an exemplary embodiment of a liquid crystal display including the liquid crystal mixture in which the terphenyl group is present (Example 2) have been shown, and the non-electric field exposure process has been carried out under the same condition.

TABLE 2

| | Residual reactive mesogen | | |
|---|---|---|---|
| | Comparative | | |
| | Example | Example 1 | Example 2 |
| | (wt %) | (wt %) | (wt %) |
| 0 min | 86.1 | 86.2 | 80.6 |
| 20 min | 3.6 | 1.5 | 2.1 |
| 40 min | 1.8 | 1.4 | 1.3 |
| 60 min | 1.4 | 1.3 | 1.2 |

Referring to Table 2, the residual reactive mesogen is more rapidly exhausted through the non-electric field exposure process in the exemplary embodiments of the liquid crystal display. In addition, in the exemplary embodiments, the liquid crystal mixture including the terphenyl group is more rapidly exhausted than the liquid crystal mixture not including the terphenyl group in the liquid crystal display. Particularly, when comparing the commercially liquid crystal display, of the Comparative Example with the exemplary embodiment of the liquid crystal display (Example 2), the gray level of the surface afterimage is represented at 191 gray level and 196 gray level, respectively. That is, the surface afterimage may be reduced in the exemplary embodiment of the liquid crystal display when compared with the conventional liquid crystal display.

As described above, since the liquid crystal molecules maintain a pre-tilt angle substantially parallel to a longitudinal direction of the branch portions of the liquid crystal molecules and the liquid crystal molecules are rapidly inclined when the electric field is formed according to the inclination direction of the liquid crystal molecules, the liquid crystal display may have a high response speed.

Table 3 shows the response speed in milliseconds (ms) and the transmittance of the conventional liquid crystal display and the exemplary embodiment of the liquid crystal display described above.

TABLE 3

| | | |
|---|---|---|
| Optical properties | Ref. | Example 2 |

| | | | |
|---|---|---|---|
| Response speed | Ton | 8.1 ms | 8.8 ms |
| | Toff | 4.1 ms | 4.1 ms |

| | | |
|---|---|---|
| transmittance | 6.84% | 6.84% |

Referring to Table 3, the exemplary embodiment of the liquid crystal display has the superior response speed and transmittance when compared with the conventional liquid crystal display.

Although exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A liquid crystal display comprising:
a first base substrate;
a pixel electrode on the first base substrate and including a plurality of branch portions;
a first alignment layer on the pixel electrode;
a second base substrate;
a common electrode on the second base substrate;
a second alignment layer on the common electrode; and
a liquid crystal layer between the first base substrate and the second base substrate, wherein
the liquid crystal layer comprises a liquid crystal expressed by the following Chemical Formulas 1 to 3, or a combination thereof, and
the first and second alignment layers comprise a polymer comprising a structural unit derived from a reactive mesogen expressed by the following Chemical Formula 4. 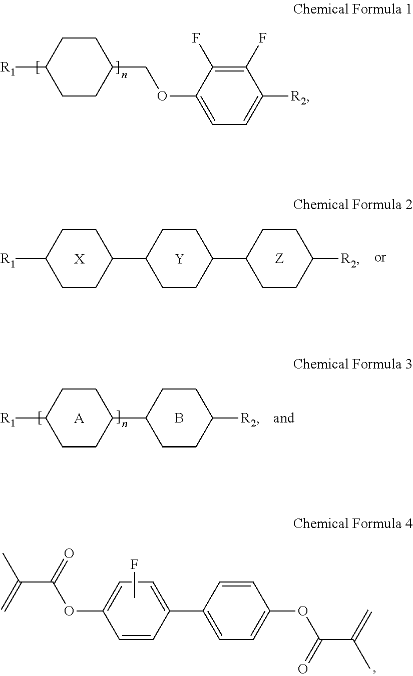
wherein
R₁ and R₂ each independently represent an alkyl group having about 1 to about 10 carbon atoms or an alkyl group having 2 to about 10 carbon atoms in which 1 or 2 —CH₂— groups are optionally replaced by —O—, —CH═CH—, —C(O)—, —OC(O)—, —(O)CO—, or —C(O)O—,
each of the rings X, Y, and Z is independently cyclohexyl or phenyl in which at least one hydrogen atom is substituted by F or Cl,
each of the rings A and B is independently cyclohexyl or phenyl, and
n is a constant number of 1 or 2.

2. The liquid crystal display of claim 1, wherein the liquid crystal layer comprises
about 10 weight percent to about 30 weight percent of the liquid crystal expressed by the Chemical Formula 1,
about 13 weight percent to about 45 weight percent of the liquid crystal expressed by the Chemical Formula 2, and
about 30 weight percent to about 60 weight percent of the liquid crystal expressed by the Chemical Formula 3.

3. The liquid crystal display of claim 2, wherein the liquid crystal expressed by the Chemical Formula 2 comprises liquid crystals expressed by the following Chemical Formulas 5 and 6:

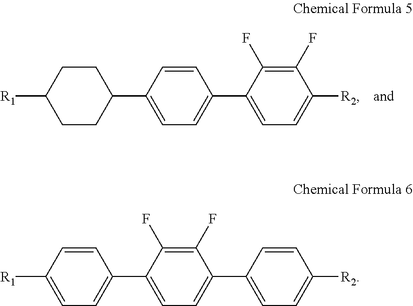

4. The liquid crystal display of claim 3, wherein the liquid crystal layer comprises
about 3 weight percent to about 15 weight percent of the liquid crystals expressed by the Chemical Formula 5, and
about 10 weight percent to about 30 weight percent of the liquid crystals expressed by the Chemical Formula 6.

5. The liquid crystal display of claim 2, wherein a structural unit derived from the reactive mesogen expressed by the Chemical Formula 4 is present in the liquid crystal layer in an amount of about 0.2 weight percent to about 0.5 weight percent, based on a total weight of the liquid crystal layer.

6. The liquid crystal display of claim 5, wherein the reactive mesogen expressed by the Chemical Formula 4 is expressed by the following Chemical Formula 7:

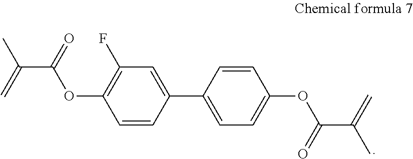 [SMILES: C=C(C)C(=O)Oc1ccc(-c2ccc(OC(=O)C(=C)C)c(F)c2)cc1 ; "."]

7. The liquid crystal display of claim 6, wherein the liquid crystal expressed by the Chemical Formula 3 is a liquid crystal expressed by the following Chemical Formulas 8A to 8D, or a combination thereof:

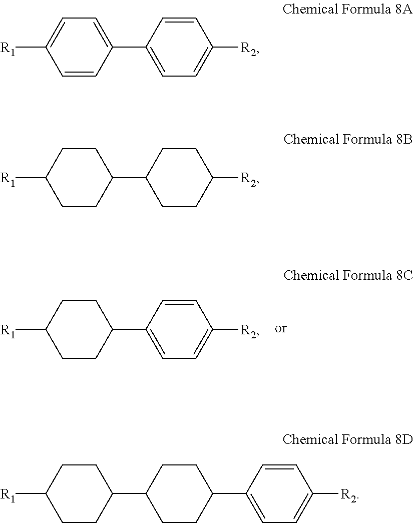

8. The liquid crystal display of claim 1, wherein the liquid crystal layer has an anisotropic refractive index of about 0.080 to about 0.130 and an anisotropic dielectric constant of about −4.0 to about −2.5.

9. The liquid crystal display of claim 1, wherein the common electrode is a single, unitary, indivisible body.

10. The liquid crystal display of claim 1, wherein the liquid crystal layer is vertically aligned liquid crystal.

11. A method of manufacturing a liquid crystal display, the method comprising;
forming a first substrate;
forming a second substrate;
disposing a liquid crystal mixture including a liquid crystal and a reactive mesogen between the first substrate and the second substrate, wherein
the liquid crystal is expressed by the following Chemical Formulas 1 to 3, or a combination thereof, and
the reactive mesogen is expressed by the following Chemical Formula 4; and
providing a light to the liquid crystal mixture to form alignment layers including a structural unit derived from the reactive mesogen on the first substrate and the second substrate, respectively, 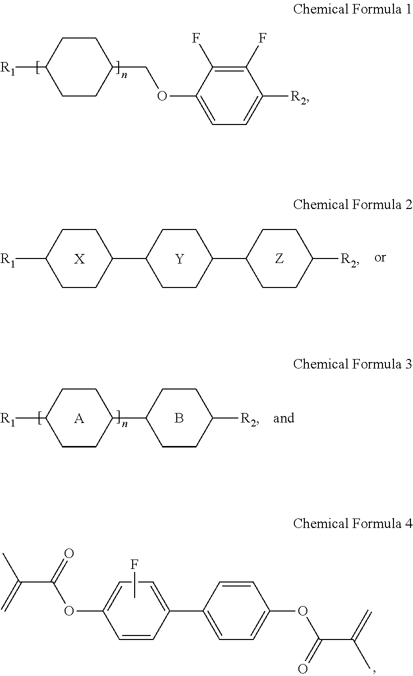
wherein
R₁ and R₂ each independently represent an alkyl group having about 1 to about 10 carbon atoms or an alkyl group having 2 to 10 carbon atoms in which 1 or 2 —CH₂— groups are optionally replaced by —O—, —CH═CH—, —C(O)—, —OC(O)—, —(O)CO—, or —C(O)O—,
each of the rings X, Y, and Z is independently cyclohexyl or phenyl in which at least one hydrogen atom is substituted by F or Cl,
each of the rings A and B is independently cyclohexyl or phenyl, and
n is a constant number of 1 or 2.

12. The method of claim 11, wherein the liquid crystal mixture comprises about 10 weight percent to about 30 weight percent of the liquid crystal expressed by the Chemical Formula 1,
about 13 weight percent to about 45 weight percent of the liquid crystal expressed by the Chemical Formula 2,
about 30 weight percent to about 60 weight percent of the liquid crystal expressed by the Chemical Formula 3, and
about 0.2 weight percent to about 0.5 weight percent of the reactive mesogen expressed by the Chemical Formula 4.

13. The method of claim 12, wherein the liquid crystal expressed by the Chemical Formula 2 comprises liquid crystals expressed by the following Chemical Formulas 5 and 6:

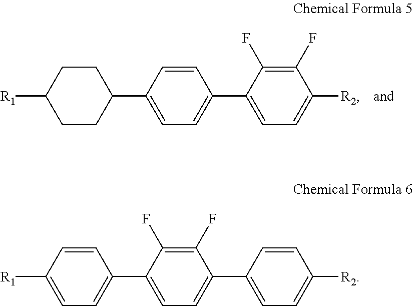

14. The method of claim 13, wherein the liquid crystal layer comprises
about 3 weight percent to about 15 weight percent of the liquid crystal expressed by the Chemical Formula 5, and
about 10 weight percent to about 30 weight percent of the liquid crystal expressed by the Chemical Formula 6.

15. The method of claim 14, wherein the reactive mesogen expressed by the Chemical Formula 4 is expressed by Chemical Formula 7:

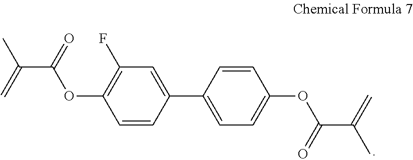 [SMILES: C=C(C)C(=O)Oc1ccc(-c2ccc(OC(=O)C(=C)C)c(F)c2)cc1]

16. The method of claim 11, wherein the liquid crystal expressed by the Chemical Formula 3 is a liquid crystal expressed by the following Chemical Formulas 8A to 8D, or a combination thereof:

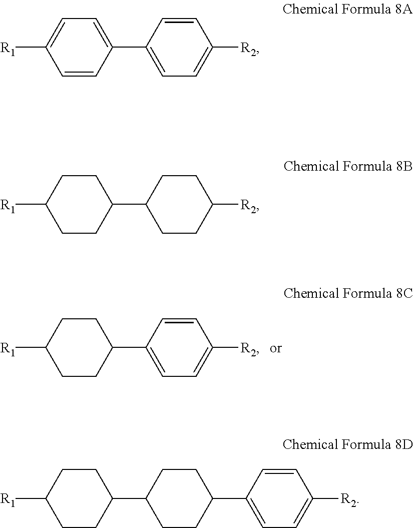

17. The method of claim 11, wherein the liquid crystal layer has an anisotropic refractive index of about 0.080 to about 0.130 and an anisotropic dielectric constant of about −4.0 to about −2.5.

18. The method of claim 11, wherein
the forming of the first substrate comprises forming a pixel electrode on a first base substrate, and
the forming of the second substrate comprises forming a common electrode on a second base substrate.

19. The method of claim 18, further comprising forming an electric field between the pixel electrode and the common electrode, wherein the forming the alignment layers is substantially simultaneous with the forming of the electric field.

20. The method of claim 18, wherein the forming the alignment layers comprises:
providing the light to the liquid crystal mixture in a state during which the electric field is formed between the pixel electrode and the common electrode; and
further providing the light to the liquid crystal mixture in a state during which the electric field is not formed between the pixel electrode and the common electrode.
